(19) United States
(12) Patent Application Publication
(10) Pub. No.: US 2017/0369353 A1
(43) Pub. Date: Dec. 28, 2017

(54) APPARATUS AND METHODS FOR PRODUCING A GLASS RIBBON

(71) Applicant: Corning Incorporated, Corning, NY (US)

(72) Inventors: Robert Delia, Horseheads, NY (US); Ahdi El-Kahlout, Lexington, KY (US)

(21) Appl. No.: 15/698,854

(22) Filed: Sep. 8, 2017

Related U.S. Application Data
(62) Division of application No. 13/163,176, filed on Jun. 17, 2011.

(51) Int. Cl. C03B 17/06

(52) U.S. Cl. CPC C03B 17/067

(57) ABSTRACT

Apparatus for producing glass ribbon comprises a plurality of cooling coils positioned along a cooling axis of the apparatus extending transverse to a draw direction. The cooling coils are configured to control a transverse temperature profile of the glass ribbon along a cooling axis. Each cooling coil can be fabricated from at least one tube and configured to circulate fluid to remove heat from the cooling coil. In further examples, methods of producing a glass ribbon include the step of controlling a transverse temperature profile of the glass ribbon along a width of the glass ribbon. The step of controlling the temperature profile includes selectively removing heat from at least one of a plurality of cooling coils positioned along the cooling axis.

### FIELD

The present invention relates generally to apparatus and methods for producing glass ribbon and, more particularly, to apparatus and methods for producing a glass ribbon with a plurality of cooling coils extending along a cooling axis that is transverse to a draw direction of the glass ribbon.

### BACKGROUND

It is known to draw a glass ribbon with a draw device. The glass ribbon may be subsequently divided to produce a plurality of glass sheets that may be employed in a wide range of applications. The glass ribbon is known to be drawn in a viscous state for eventual cooling into an elastic state where final features are permanently set into the glass sheet.

### SUMMARY

The following presents a simplified summary of the disclosure in order to provide a basic understanding of some example aspects described in the detailed description.

In one example aspect, an apparatus for producing glass ribbon comprises a drawing device configured to draw molten glass into a glass ribbon in a draw direction along a draw plane of the apparatus. The apparatus further includes a cooling apparatus including a plurality of cooling coils positioned along a cooling axis of the apparatus extending transverse to the draw direction. The cooling coils are configured to control a transverse temperature profile of the glass ribbon along the cooling axis. Each cooling coil is fabricated from at least one tube and configured to circulate fluid through the at least one tube to remove heat from the cooling coil.

In another example aspect, a method of producing a glass ribbon includes the step of drawing molten glass in a draw direction into a viscous zone to form a glass ribbon including opposed edges extending in the draw direction. The opposed edges are spaced apart along a width of the glass ribbon that is transverse to the draw direction. The method further includes the step of drawing the molten glass from the viscous zone into a setting zone downstream from the viscous zone, wherein the glass ribbon is set from a viscous state to an elastic state. The method further includes the step of drawing the glass ribbon into an elastic zone downstream from the setting zone. The apparatus also includes the step of controlling a transverse temperature profile of the glass ribbon along the width of the glass ribbon in at least one of the viscous zone, the setting zone and the elastic zone. The step of controlling the temperature profile includes selectively removing heat from at least one of a plurality of cooling coils positioned along a cooling axis that is transverse to the draw direction.

### BRIEF DESCRIPTION OF THE DRAWINGS

These and other features, aspects and advantages of the present disclosure are better understood when the following detailed description is read with reference to the accompanying drawings, in which:

FIG. 1 is a schematic illustration of an example fusion draw apparatus including a cooling apparatus in accordance with aspects of the disclosure;

FIG. 2 illustrates a sectional view of a forming vessel of the fusion draw apparatus of FIG. 1;

FIG. 3 schematically illustrates a glass ribbon being drawn off the forming vessel of FIG. 1;

FIG. 4 illustrates a cooling apparatus in accordance with one example aspect of the disclosure;

FIG. 5 is a cross-sectional view along line 5-5 of FIG. 4, illustrating features of the cooling apparatus of FIG. 4;

FIG. 6 is a cross-sectional view along line 6-6 of FIG. 4, illustrating features of the cooling apparatus of FIG. 4; and

FIG. 7 illustrates a method of replacing a control module of the cooling apparatus with a new control module.

### DETAILED DESCRIPTION

Methods will now be described more fully hereinafter with reference to the accompanying drawings in which example embodiments of the disclosure are shown. Whenever possible, the same reference numerals are used throughout the drawings to refer to the same or like parts. However, this disclosure may be embodied in many different forms and should not be construed as limited to the embodiments set forth herein.

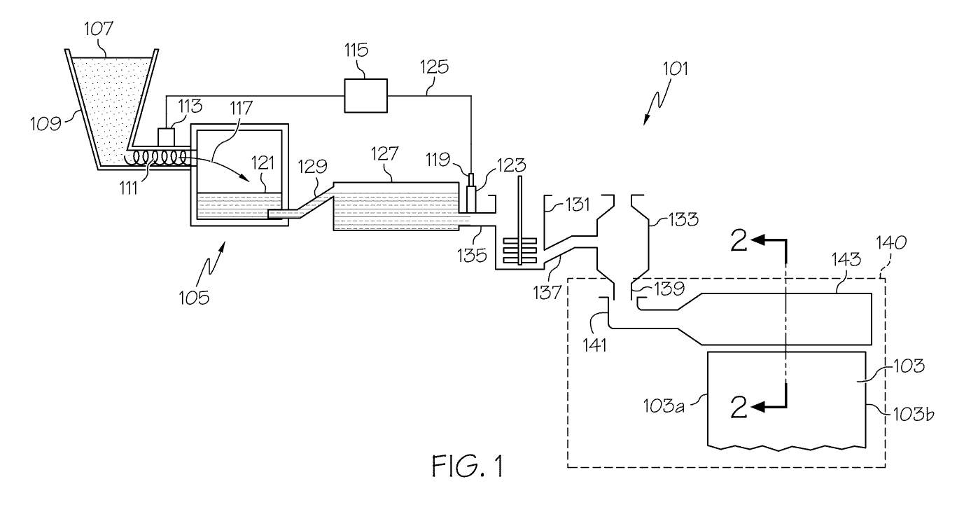

Apparatus can be provided to form a glass ribbon for subsequent processing into glass sheets. FIG. 1 schematically illustrates a fusion draw apparatus 101 although up draw, slot draw or other glass forming techniques may be used with aspects of the disclosure in further examples. With such fusion draw process techniques, the present disclosure provides for control of viscosity and temperature cooling curves to provide process stability and facilitate quality performance. For instance, proper cooling below a forming vessel can help provide the glass ribbon with sufficient cooling and high-enough viscosity to minimize ribbon bagginess, i.e., the tendency of the ribbon to deform uncontrollably, such as unevenly under its own weight. Proper cooling below the forming vessel can also help stabilize thickness and provide shape control. Furthermore, proper cooling can help provide proper transitioning and conditioning of the glass into the visco-elastic region where final glass flatness, stress, and shape is controlled.

As illustrated, the fusion draw apparatus 101 can include a melting vessel 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. A metal probe 119 can be used to measure a glass melt 121 level within a standpipe 123 and communicate the measured information to the controller 115 by way of a communication line 125.

The fusion draw apparatus 101 can also include a fining vessel 127, such as a fining tube, located downstream from the melting vessel 105 and coupled to the melting vessel 105 by way of a first connecting tube 129. A mixing vessel 131 such as a stir chamber, can also be located downstream from the fining vessel 127 and a delivery vessel 133 may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver glass melt 121 from the delivery vessel 133 to a fusion draw machine 140. The fusion draw machine 140 can include the a forming vessel 143 provided with an inlet 141 to receive glass melt from the downcomer 139.

As shown, the melting vessel 105, fining vessel 127, the mixing vessel 131, delivery vessel 133, and forming vessel 143 are examples of glass melt stations that may be located in series along the fusion draw apparatus 101.

The melting vessel 105 is typically made from a refractory material, such as refractory (e.g. ceramic) brick. The fusion draw apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide. The platinum-containing components can include one or more of the first connecting tube 129, the fining vessel 127 (e.g., finer tube), the second connecting tube 135, the standpipe 123, the mixing vessel 131 (e.g., a stir chamber), the third connecting tube 137, the delivery vessel 133 (e.g., a bowl), the downcomer 139 and the inlet 141. The forming vessel 143 is also made from a refractory material and is designed to form the glass ribbon 103.

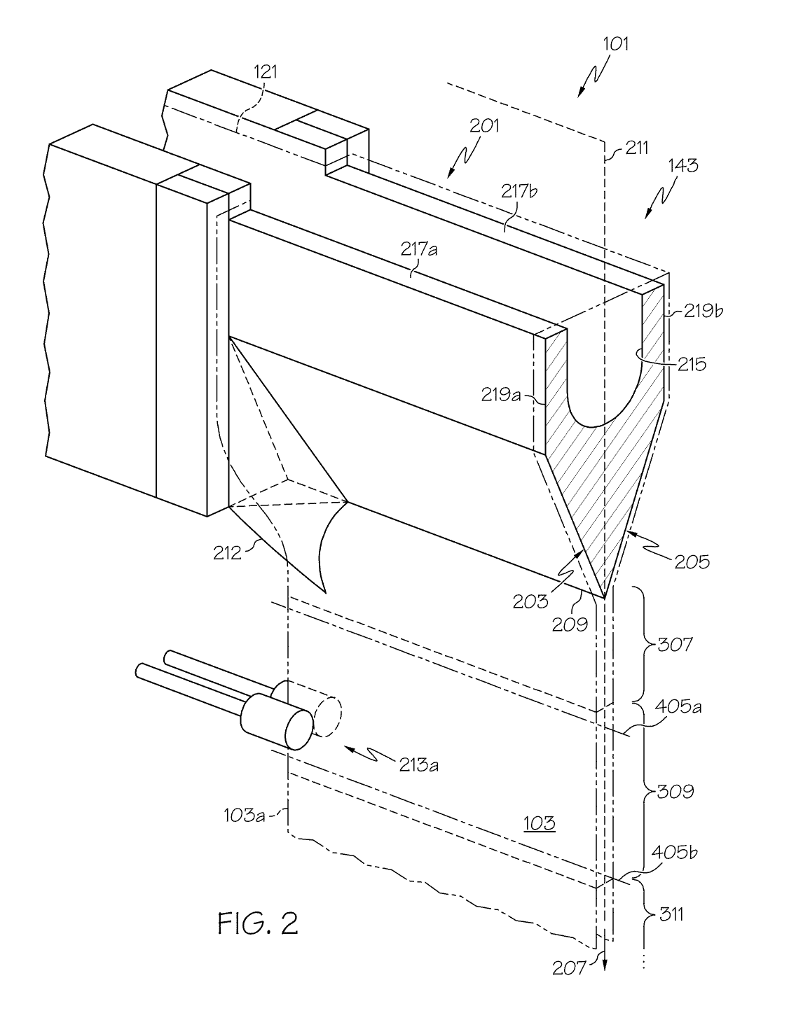

FIG. 2 is a cross-sectional perspective view of the fusion draw apparatus 101 along line 2-2 of FIG. 1. As shown, the forming vessel 143 includes a forming wedge 201 comprising a pair of downwardly inclined forming surface portions 203, 205 extending between opposed ends of the forming wedge 201. The pair of downwardly inclined forming surface portions 203, 205 converge along a draw direction 207 to form a root 209. A draw plane 211 extends through the root 209 wherein the glass ribbon 103 may be drawn in the draw direction 207 along the draw plane 211. As shown, the draw plane 211 can bisect the root 209 although the draw plane 211 may extend at other orientations with respect to the root 209.

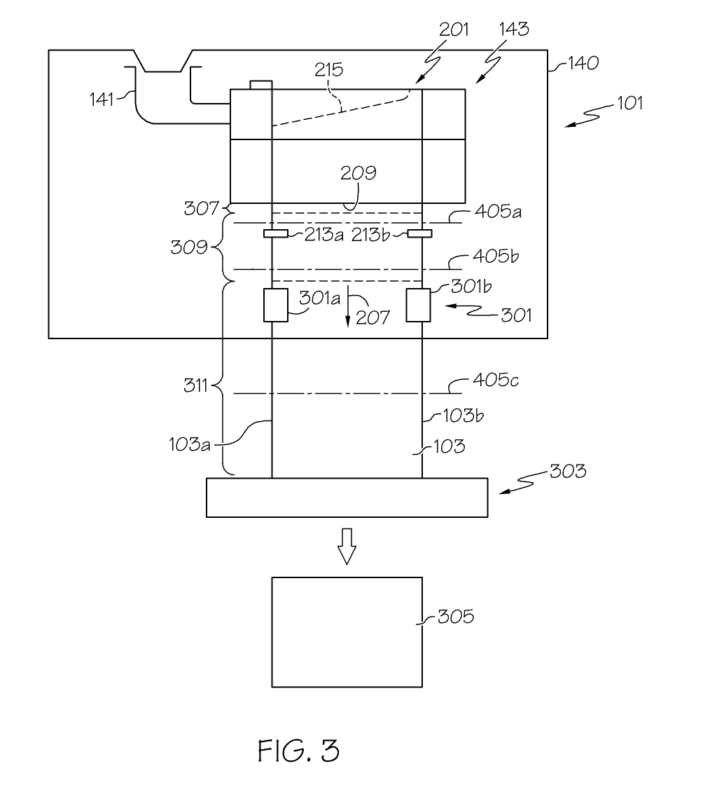

The fusion draw apparatus 101 for fusion drawing a glass ribbon can also include at least one edge roller assembly including a pair of edge rollers configured to engage a corresponding edge 103a, 103b of the glass ribbon 103 as the ribbon is drawn off the root 209 of the forming wedge 201. The pair of edge rollers facilitates proper finishing of the edges of the glass ribbon. Edge roller finishing provides desired edge characteristics and proper fusion of the edge portions of the molten glass being pulled off opposed surfaces of an edge director 212 associated with the pair of downwardly inclined forming surface portions 203, 205. As shown in FIG. 2, a first edge roller assembly 213a is associated with the first edge 103a. FIG. 3 shows a second edge roller assembly 213b associated with the second edge 103b of the glass ribbon 103. Each edge roller assembly 213a, 213b can be substantially identical to one another although the pairs of edge rollers may have different characteristics in further examples.

As shown in FIG. 3, the fusion draw apparatus 101 can further include a first and second pull roll assembly 301a, 301b for each respective edge 103a, 103b to facilitate pulling of the glass ribbon 103 in the draw direction 207 of the draw plane 211.

The fusion draw apparatus 101 can further include a cutting device 303 that allows the glass ribbon 103 to be cut into distinct glass sheets 305. The glass sheets 305 may be subdivided into individual glass sheets for incorporating in the various display devices, such as a liquid crystal display (LCD). Cutting devices may include laser devices, mechanical scoring devices, traveling anvil machines and/or other devices configured to cut the glass ribbon 103 into the distinct glass sheets 305.

Referring to FIG. 2, in one example, the glass melt 121 can flow into a trough 215 of the forming vessel 143. The glass melt 121 can then simultaneously flow over corresponding weirs 217a, 217b and downward over the outer surfaces 219a, 219b of the corresponding weirs 217a, 217b. Respective streams of glass melt then converge along the downwardly inclined forming surface portions 203, 205 to the root 209 of the forming vessel 143. A glass ribbon 103 is then drawn off the root 209 in the draw plane 211 along draw direction 207.

Turning to FIG. 3, the glass ribbon 103 is drawn from the root 209 in the draw direction 207 of the draw plane 211 from a viscous zone 307 to a setting zone 309. In the setting zone 309, the glass ribbon 103 is set from a viscous state to an elastic state with the desired cross-sectional profile. The glass ribbon is then drawn from the setting zone 309 to an elastic zone 311. In the elastic zone 311, the profile of the glass ribbon from the viscous zone 307 is frozen as a characteristic of the glass ribbon. While the set ribbon may be flexed away from this configuration, internal stresses can cause the glass ribbon to bias back to the original set profile.

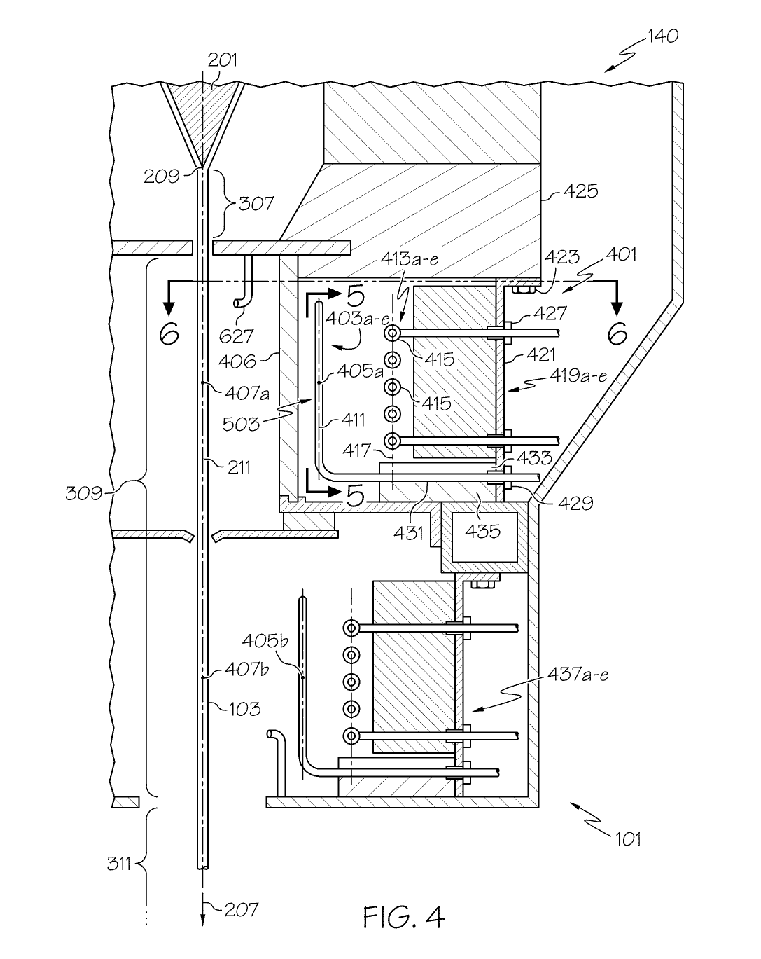

Any of the apparatus for producing glass ribbon can include a cooling apparatus configured to control a transverse temperature profile of the glass ribbon along a cooling axis. For example, the fusion draw apparatus 101 is illustrated as including a cooling apparatus. FIG. 4 illustrates one example cooling apparatus 401 in accordance with aspects of the disclosure although other cooling apparatus configurations may be provided in further examples. The cooling apparatus 401, for example, may be part of the fusion draw machine 140 that has been schematically represented in FIGS. 1-3. The details of the cooling apparatus 401 are not illustrated in FIGS. 1-3 for clarity but aspects of an example cooling apparatus 401 is more fully shown in FIGS. 4-7.

FIGS. 4-7 illustrate an example apparatus for producing glass ribbon that may comprise the illustrated fusion draw apparatus 101, although up draw or other glass forming apparatus may also be provided with a cooling apparatus in accordance with aspects of the disclosure. As shown in FIGS. 4-6, the illustrated cooling apparatus 401 can include a plurality of cooling coils 403a-e positioned along a cooling axis 405a of the fusion draw apparatus 101. As illustrated, the cooling axis 405a can be designed to extend transverse, such as substantially perpendicular, to the draw direction 207. For example, as shown in FIG. 3, the cooling axis 405a can be substantially perpendicular to the draw direction 207 while being positioned in an upper portion of the setting zone 309 where the glass ribbon 103 begins to transition from a viscous state to an elastic state. As shown in FIG. 4, in such a position a heat shield 406 may be provided to protect structures of the fusion draw machine 140. The heat shield 406 can comprise a SiC material although other materials may be used in further examples.

In addition or alternatively, as shown in FIGS. 3 and 4, the cooling axis 405b may be located in a lower portion of the setting zone 309 where the glass ribbon 103 finalizes the transition from the viscous state to an elastic state. Still further, as shown schematically in FIG. 3, the cooling axis 405c may be located in the elastic zone 311 where the glass ribbon is fully set in the elastic state. In fact, it will be appreciated that the cooling axis can be located at various positions of the glass ribbon traveling from the forming vessel 143. For instance, in the illustrated example, the cooling axis may be located at various alternative positions of the glass ribbon between the root 209 of the forming wedge 201 and the cutting device 303.

Providing a cooling axis may be beneficial to help control a transverse temperature profile of the glass ribbon 103 along the cooling axis. For example, the transverse temperature profile can be located substantially along a profile axis of the glass ribbon. FIG. 4 illustrates an example where a temperature profile axis 407a of the glass ribbon 103 is substantially perpendicular to the draw direction 207 and parallel to the corresponding cooling axis 405a. Likewise, another temperature profile axis 407b of the glass ribbon 103 is substantially perpendicular to the draw direction 207 and parallel to the corresponding cooling axis 405b. As such, it will be appreciated that the profile axis (e.g., 407a and 407b) may be substantially perpendicular to the draw direction 207 and likewise substantially perpendicular to the elongated axis of the glass ribbon. Still further the profile axis may be substantially perpendicular to the edges 103a, 103b of the glass ribbon although the profile axis may be oriented at an oblique angle with respect to the edges 103a, 103b and/or the draw direction 207.

As such, apparatus and methods of the present disclosure can facilitate control of the transverse temperature of the glass ribbon 103 along the cooling axis at various locations along the draw direction 207 of the glass ribbon 103. Allowing control of the transverse temperature of the glass ribbon can facilitate control of the transverse viscosity and/or temperature cooling curves in a transverse direction of the glass ribbon 103.

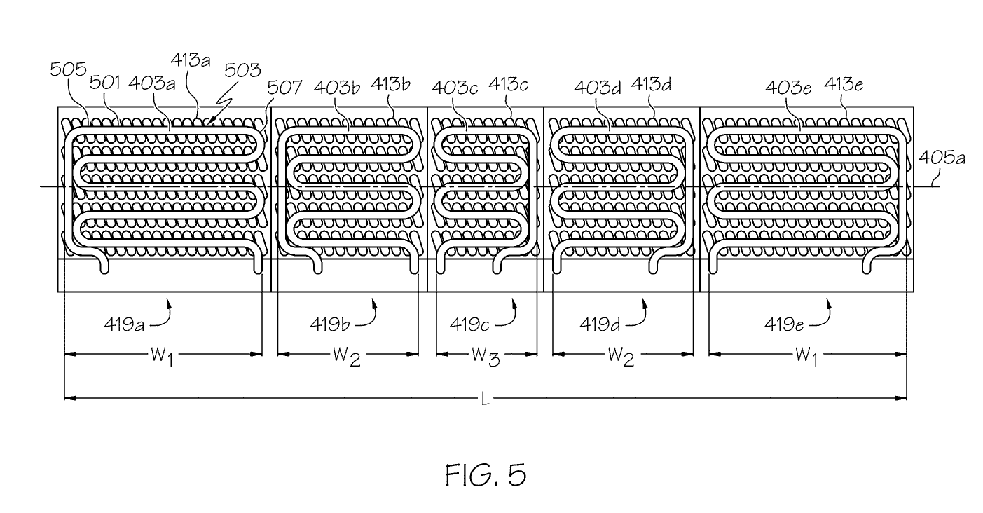

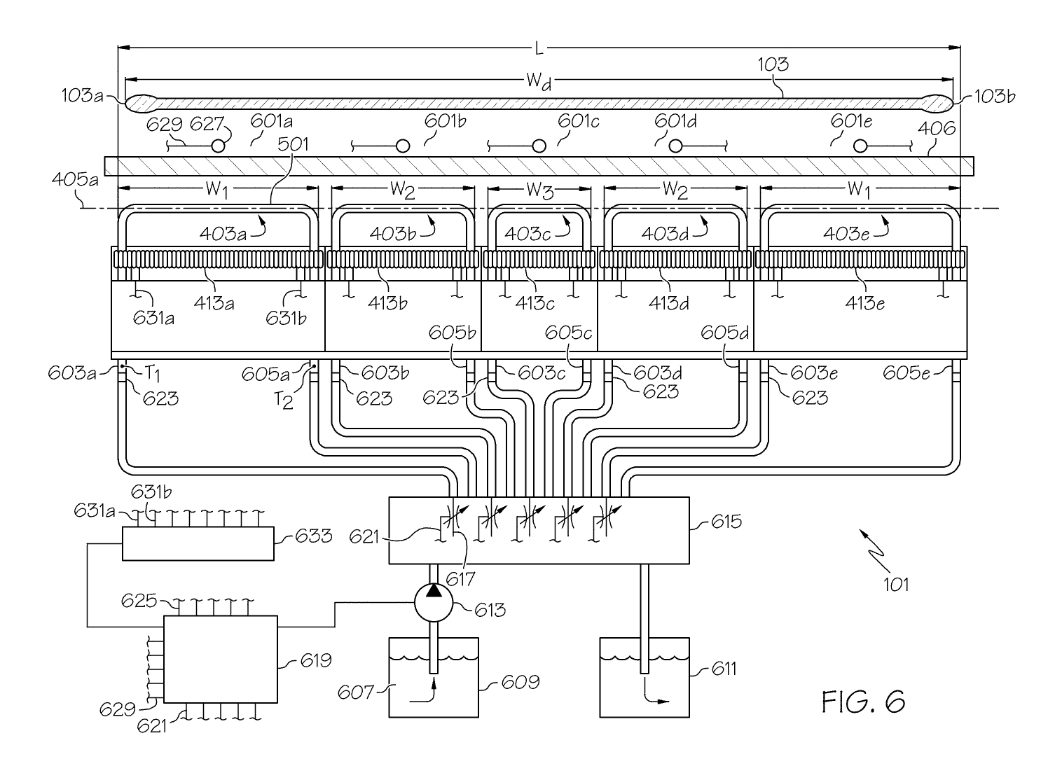

The plurality of cooling coils 403a-e referenced in FIG. 4 is illustrated in FIGS. 5-6. FIG. 5 is a cross-sectional view of portions of the fusion draw machine 140 along line 5-5 of FIG. 3. For illustrative purposed, FIG. 5 shows a plurality of cooling coils 403a-e including five cooling coils 403a-e although more or less cooling coils may be provided in further examples.

Each cooling coil can be fabricated from at least one tube and configured to circulate fluid through the at least one tube to remove heat from the cooling coil. As such, liquid and/or gas cooling fluid may be used to circulate through the tube without physically contacting the glass ribbon or other portions of the fusion draw apparatus 101. In one example, the tube can be configured to circulate liquid to increase the rate at which heat transfer is removed from the respective cooling zone. As such, the at least one tube can move liquid into the vicinity of the cooling zone without contaminating electrical components or other structures of the fusion draw machine. Thus, the benefits of high heat transfer associated with liquid cooling with a cooling coil including at least one tube can be achieved without contacting the other portions of the apparatus.

In one example, the at least one cooling coil can include a plurality of cooling coils or segments of coils that are joined together. In further examples, one or more of the coils may be formed with a seam, either at the interfaces between the segments and/or along a longitudinal axis of the cooling tubes. For example, a plurality of straight segments may be welded, soldered, or otherwise joined together with a plurality of elbow or U-shaped segments. Alternatively, as shown in FIG. 5, the at least one tube of each cooling coil can comprise a single substantially continuous tube 501 that is bent into a compact shape 503. The single substantially continuous tube 501 can be provided without any weld or solder seams along a compact shape 503 of the cooling coil (e.g., along a longitudinal axis of a cooling tube) although the compact shape 503 may be provided by more than one tube and/or a tube with seams. However, providing the cooling coil with the illustrated single continuous tube without seams can reduce the probability of cracks, fluid leaks and/or catastrophic failure of the cooling coil that may otherwise damage electrical and other components of the apparatus in the vicinity of the cooling coils.

Various compact shapes may be used in accordance with aspects of the disclosure. For example, as shown in FIG. 5, the compact shape 503 can include a serpentine shape. The serpentine shape can allow the at least one tube to achieve a compact form to increase the surface area of the cooling coil within the corresponding cooling zone. For instance, as shown in FIG. 5, the serpentine shape can include a plurality of straight segments 505 joined together at bent ends 507.

As shown in FIG. 4, the compact shape 503 of each of the cooling coils 403a-e can extend along a cooling plane 411. In such a configuration, the serpentine shape can substantially extend along the cooling plane 411 such that the straight segments 505 and bent ends 507 are substantially coplanar with one another. In such an example, relatively consistent cooling can be achieved above and below the temperature profile axis 407a, 407b. As further illustrated, the cooling plane 411 faces the draw plane 211. In one example, the cooling plane 411 can be positioned at an angle to the draw plane 211 to allow a change in heat transfer along a height of the cooling coils 403a-e. Alternatively, as shown, the cooling plane 411 can be substantially parallel to the draw plane 211. Providing a substantially parallel relative orientation can help evenly draw heat from the glass ribbon to facilitate maintenance of a desired temperature profile over the height of the cooling zone along the draw direction 207.

Referring to FIG. 5, the plurality of cooling coils 403a-e can be aligned relative to one another in a row of cooling coils 403a-e extending along the cooling axis 405a. Although a single row is shown, further examples may include cooling coils arranged in an array of cooling coils having multiple rows. In such examples, the cooling coils may also be aligned along respective columns to form a matrix of cooling coils.

As further illustrated, the plurality of cooling coils 403a-e can each include a corresponding transverse width “W₁”, “W₂” and “W₃” extending along the cooling axis of the apparatus. As shown, the transverse width of at least one of the plurality of cooling coils is greater than the transverse width of another of the plurality of cooling coils. For example, the center of the glass ribbon may be associated with one or more cooling coils that have a smaller transverse width than the outer cooling coils. For instance, by way of illustration, the row of cooling coils 403a-e can include the illustrated inner cooling coil 403c with a transverse width “W₃” that is less than the transverse width “W₂” of an inner pair of cooling coils 403b, 403d straddling the inner cooling coil 403c. Likewise, the row of cooling coils 403a-e can include an outer pair of cooling coils 403a, 403e with a width “W₁” that can be greater than the width “W₂” of the inner pair of cooling coils 403b, 403d and the width “W₃” inner cooling coil 403c.

In further examples, one or more of the cooling coils may include the same width. For example as shown, the inner pair of cooling coils 403b, 403d have the same transverse width “W₂” and the outer pair of cooling coils 403a, 403e has the same transverse width “W₁”. Providing cooling coils with different and/or the same width can help compensate cooling and/or heating of the glass ribbon 103 at different distances from the center of the glass ribbon. Moreover, the cooling coils may have a different width to correspond to the transverse width of a plurality of heating devices described more fully below.

As shown in FIG. 6, each transverse width “W₁”, “W₂” and “W₃” of the plurality of cooling coils 403a-e is substantially less than a draw width “W_{d}” of the fusion draw apparatus 101. As shown in FIG. 6, the fusion draw width “W_{d}” can be considered a transverse width of the glass ribbon 103 along a direction perpendicular to the draw direction 207 between the edges 103a, 103b. Providing each cooling coil 403a-e with transverse widths “W₁”, “W₂” and “W₃” that are substantially less than the draw width “W_{d}” of the fusion draw apparatus 101 can allow selective cooling within cooling zones 601a-e to help achieve the desired temperature profile along the cooling axis 405a.

The row of cooling coils 403a-e can also be aligned relative to one another in a row of cooling coils 403a-e along the cooling axis 405a such that an overall length “L” of the cooling coils is greater than or about equal to the draw width “W_{d}” of the fusion draw apparatus 101. While smaller lengths are possible, providing the length “L” greater than or about equal to the draw width “W_{d}” can allow transverse temperature profile control across the entire width of the glass ribbon 103.

As shown in FIG. 6, each of the cooling coils 403a-e can be independently operable from the other cooling coils. For example, each of the plurality of cooling coils 403a-e can include a respective inlet 603a-e configured to receive a cooling fluid such as a gas and/or liquid. For example, as shown, each respective inlet 603a-e can be provided with a cooling liquid 607, such as water, from a source 609 of cooling liquid 607. Each of the cooling coils 403a-e can also include a respective outlet 605a-e configured to pass heated liquid from the cooling coil to a containment structure 611, although a closed liquid circuit arrangement may be provided in further examples. In such examples, a heat exchanger can be used to remove heat from the heated fluid before reintroducing the cooled fluid back into the respective inlet 603a-e.

In one example, a pump 613 may be provided to pump liquid to the respective inlets 603a-e to be circulated through the cooling coils 403a-e. In one example, a manifold 615 may be provided with a plurality of solenoid flow valves 617 that may be manually or automatically operated to adjust the flow rate of fluid through the respective cooling coil 403a-e. In one example, a computer controller 619 may be provided to send signals along a respective line 621 to the respective solenoid flow valve 617. In further examples, a predetermined flow for each respective cooling coil 403a-e may be programmed into the computer or calculated by the computer by further inputs. In one example, a flow sensor 623 can monitor the fluid flow within each cooling coil 403a-e and provide a signal by way of a respective communication line 625 to the computer controller 619. As such, the actual fluid flow through each respective cooling coil 403a-e can be monitored by the respective flow sensor 623. The fluid flow signal can then be provided to the computer controller 619 that can then output a command signal to operate the pump 613 and adjust the respective solenoid flow valve 617 to provide the appropriate flow rate through the corresponding cooling coil 403a-e. Although not shown, each fluid circuit may include a pressure relief valve although not required in further examples.

As further shown in FIG. 6, each of the inlets 603a-e may be provided with a corresponding inlet temperature sensor T₁ and each of the outlets 605a-e may be provided with a corresponding outlet temperature sensor T₂. As such, the inlet and outlet temperatures of the fluid entering and exiting each of the cooling coils 403a-e may be monitored. The computer controller 619 can be programmed to calculate the change in temperature (i.e., ΔT) measured by the temperature sensors T₁, T₂. Moreover, the computer controller 619 can be programmed with the specific heat of the fluid being circulated through the cooling coils 403a-e. Together with the flow rate of the fluid measured by the flow sensors 623, the computer controller 619 may approximate the heat being removed by each cooling coil 403a-e. This information may be further used to help optimize the temperature control within the cooling zones 601a-e.

In further examples, the apparatus can include a plurality of heat sensors 627 associated with each of the cooling zones 601a-e. The heat sensors 627 can be configured to monitor the temperature of the glass ribbon at different positions along the transverse profile. In one example, each heat sensor 627 can include a communication line 629 configured to allow a signal corresponding to the sensed temperature to be transmitted back to the computer controller 619. As such, a temperature of the portion of the glass ribbon 103 associated with each cooling zone 601a-e may monitored. Based on the sensed temperature, the flow of fluid through each cooling coil 403a-e may be independently operated from the other cooling coils to achieve a desired transverse temperature profile of the glass ribbon 103 along the cooling axis 405a. As such, the illustrated configuration provides a control system configured to selectively operate the cooling coils based on corresponding temperatures sensed at different positions along the transverse profile.

As shown in FIGS. 4-7, the fusion draw apparatus 101 may also optionally include a plurality of heating devices 413a-e positioned along the cooling axis 405a. Various heating devices may be used in accordance with aspects of the disclosure. For example, as shown in FIG. 4, the heating devices 413a-e can include rows of heating elements 415 that may be electrically arranged in parallel or series with respect to one another. Each row of heating elements 415 can be designed to achieve different temperatures to allow production of a temperature gradient in the draw direction 207. In further examples, each row of heating elements 415 can be designed to achieve substantially the same temperature to expose a portion of the ribbon to substantially the same heated temperature as the portion of the glass passes by the heating devices 413a-e.

As also shown in FIG. 4, the heating elements 415 can each extend along a heating plane 417. In one example, the heating plane 417 is positioned at an angle to the draw plane 211 and/or the cooling plane 411 to allow a change in heat transfer as a portion of the glass ribbon 103 passes by the heating plane 417. Alternatively, as shown, the heating plane 417 can be substantially parallel to the cooling plane 411 and the draw plane 211 although the heating plane 417 may only be substantially parallel with the cooling plane 411 or the draw plane 211 in further examples. Providing a substantially parallel relative orientation can help evenly apply heat to the glass ribbon to facilitate maintenance of a desired temperature profile over the height of the cooling zone (or heat zone) along the draw direction 207.

Referring to FIG. 5, the plurality of heating devices 413a-e can be aligned relative to one another in a row of heating devices 413a-e also extending along the cooling axis 405a together with the row of cooling coils 403a-e. Although a single row is shown, further examples may include heating devices arranged in an array of heating devices having multiple rows. In such examples, the heating devices may also be aligned along respective columns to form a matrix of cooling coils.

As further illustrated, the plurality of heating devices 413a-e can also include a corresponding transverse width that may be about equal to a corresponding one of the cooling coils 403a-e. As such, as shown in FIG. 5, each of the heating devices can include a transverse width that is substantially equal to the transverse width “W₁”, “W₂” and “W₃” of the corresponding cooling coil. As described with the cooling coils above, the heating devices may likewise have the same or different widths. Providing heating devices with the same and/or different widths can help compensate for faster cooling that typically occurs towards the edges 103a, 103b of the glass ribbon 103.

As shown in FIG. 6, each transverse width “W₁”, “W₂” and “W₃” also corresponding to the widths of the heating devices 413a-e is likewise substantially less than a draw width “W_{d}” of the fusion draw apparatus 101. Providing each of the heating devices 413a-e with a corresponding transverse width “W₁”, “W₂” and “W₃” that is substantially less than the draw width “W_{d}” of the fusion draw apparatus 101 can allow selective heating within cooling zones 601a-e to help achieve the desired temperature profile along the cooling axis 405a. The row of heating devices 413a-e can also be aligned relative to one another in a row of heating devices 413a-e along the cooling axis 405a such that a length “L” is greater than or about equal to the draw width “W_{d}” of the fusion draw apparatus 101. While smaller lengths are possible, providing the length “L” greater than or about equal to the draw width “W_{d}” can allow transverse temperature profile control across the entire width of the glass ribbon 103.

As shown in FIG. 6, each of the heating devices 413a-e can be independently operable from the other heating devices. For example, each of the plurality of heating devices 413a-e can include electrical contacts 631a, 631b configured to be placed in an electrical circuit to allow heating of the windings of the heating device when running electrical current through the windings. In one example, an electrical relay 633 is configured to receive signals from the computer controller 619 to individually control the current flowing through the electrical contacts 631a, 631b depending on the desired heat output determined desirable at each cooling zone 601a-e. In further examples, a predetermined electrical current for each one of the respective heating devices 413a-e may be programmed into the computer controller or calculated by the computer controller by further inputs.

In still further examples, electrical current flow through each of the heating devices 413a-e can be independently operated based on the sensed temperature from the plurality of optional heat sensors 627. As such, the illustrated apparatus provides a control system configured to selectively operate the heating devices based on corresponding temperatures sensed at different positions along the transverse profile.

In further examples, one or more of the cooling coils 403a-e may be associated with each of the heating devices 413a-e. Alternatively, one or more of the heating devices 413a-e may be associated with each of the cooling coils 403a-e. As shown in FIGS. 5-6, each of the plurality of heating devices 413a-e may be associated with a corresponding one of the cooling coils 403a-e. In some examples, the heating devices 413a-e may be operated at the same time as the cooling coils 403a-e. As such, fine tune adjustment of cooling within each respective cooling zone 601a-e may be provided by operating the heating device together with the respective cooling device. Alternatively, the cooling coils 403a-e may be turned off wherein cooling is carried out by only operating the heating devices that control the temperature profile. In such examples, the at least one tube of the cooling coil may comprise a wide range of materials capable of withstanding high temperatures when only operating the heating devices. For example, the at least one tube can comprise a high nickel alloy, 310 stainless steel or other high temperature materials.

Still further, it is contemplated that the cooling coils may optionally be provided with a coating to obtain a desired emissivity of the material to thereby impact radiation heat loss from the glass ribbon. In addition or alternatively, the same or a different coating may also be provided to inhibit corrosion. As such, one or more coatings may be applied to the cooling coils to enhance emissivity characteristics and/or enhance corrosion resistance.

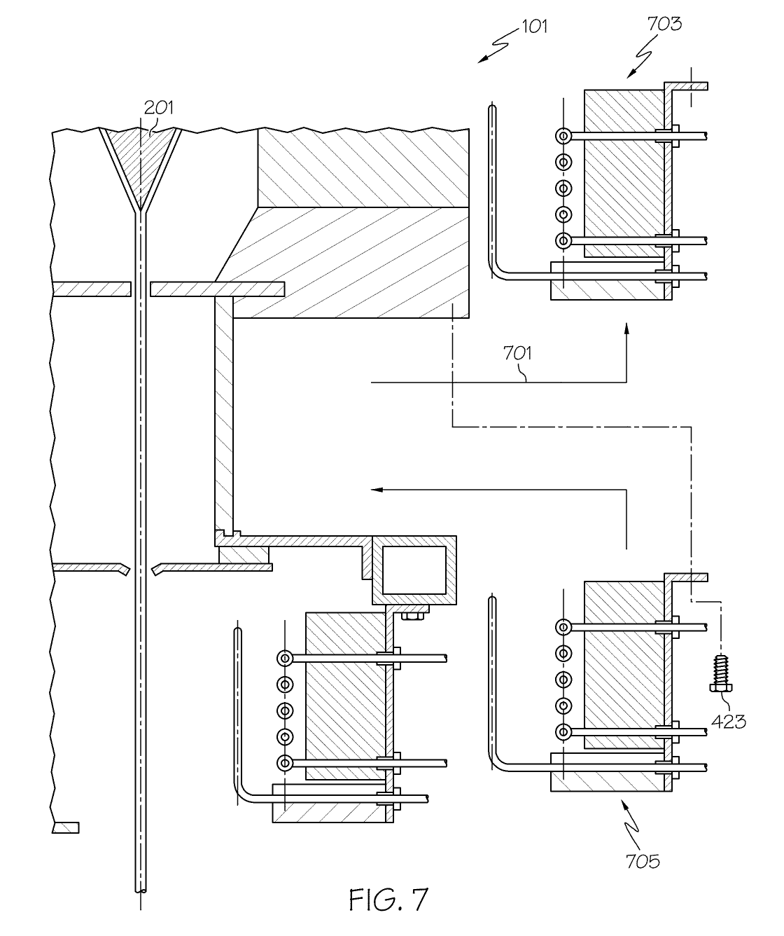

As shown schematically in FIGS. 4 and 7, the fusion draw apparatus 101 can include a plurality of temperature control modules 419a-e positioned along the cooling axis 405a of the fusion draw apparatus 101, wherein each of the control modules 419a-e includes at least one of the plurality of cooling coils 403a-e and at least one of the plurality of heating devices 413a-e. As shown in FIG. 4, each temperature control module 419a-e can be mounted with respect to the draw device, such as the illustrated forming wedge 201, such that the corresponding cooling coil 403a-e is positioned between the corresponding heating device 413a-e and the draw plane 211 of the fusion draw apparatus 101.

Still further, as shown in FIGS. 4 and 7, each temperature control module 419a-e may be removably mounted with respect to the draw device although nonremovable mounting configurations may be used in further examples. For example, as schematically shown in FIG. 4, a mounting bracket 421 can be removably mounted by way of fasteners 423 to a support structure 425 of the fusion draw apparatus 101. Another set of fasteners 427 can attach the heating devices 413a-e to the mounting bracket 421. Yet another set of fasteners 429 can attach the cooling coils 403a-e to the mounting bracket 421. As shown, the tube 501 can include a mounting segment 431 that may be received within a mounting groove 433 formed in an insulating brick 435 associated with the corresponding heating device 413a-e. As shown, the mounting groove 433 can receive a corresponding mounting segment 431 of the tube 501 to help provide a secure mounting of the compact shape 503 of the cooling coil 403a-e in a cantilever fashion with respect to the insulating brick 435. Although not shown, further optional mounting structures may be provided in accordance with further aspects of the disclosure.

As shown, the mounting bracket 421 provides for removable mounting of the temperature control module 419a-e with respect to the draw device. For example, as shown in FIG. 7, a selected one of the temperature control modules 419a-e may be removed by unfastening mounting fasteners 423 corresponding to the selected control module. As shown by the arrow 701, the old control module 703 may be quickly removed and replaced by a new control module 705. As such, a selected control module may be quickly replaced without the need to replace the other control modules. Furthermore, it is possible to replace a damaged heating device and/or cooling coil associated with the old control module 703 while drawing molten glass in the draw direction and without shutting down the fusion draw process. The old control module can then be refurbished to provide for another replacement module in the future.

As discussed previously, the cooling coil and/or heating device may be provided at various locations. As shown in FIG. 4, another temperature control module 437a-e may be provided along the cooling axis 405b located in the lower portion of the setting zone 309. The temperature control modules 437a-e may be substantially identical to the control modules 419a-e described above. Alternatively, as shown, the temperature control modules 437a-e may be a different size than the control modules 419a-e. In still further examples, only a cooling device or heating device may be provided along the cooling axis 405b in further examples.

In operation, methods of producing a glass ribbon 103 can include the steps of drawing molten glass in the draw direction 207 into the viscous zone 307 to form the glass ribbon 103 including the opposed edges 103a, 103b extending in the draw direction 207. As shown in FIGS. 1 and 3, the opposed edges 103a, 103b are spaced apart along the width of the glass ribbon 103 that is transverse to the draw direction 207.

The method then includes the step of drawing the molten glass from the viscous zone 307 to the setting zone 309 downstream from the viscous zone 307. In the setting zone 309, the glass ribbon 103 is set from a viscous state to an elastic state. The method further includes the step of drawing the glass ribbon 103 into the elastic zone 311 downstream from the setting zone 309. Optionally, the cutting device 303 may then be used to cut distinct glass sheets 305 from the glass ribbon 103 for further processing. Although not shown, the edges of the glass ribbon may be trimmed and/or the glass ribbon may be coiled into a storage spool for carrying out further cutting techniques at another location.

The method further includes the step of controlling a transverse temperature profile of the glass ribbon 103 along the width of the glass ribbon 103 in at least one of the viscous zone 307, the setting zone 309 and the elastic zone 311. The step of controlling the temperature profile includes selectively removing heat from at least one of a plurality of cooling coils 403a-e positioned along the cooling axis 405a that is transverse to the draw direction 207.

As shown in FIG. 6, the step of removing heat from the cooling coils can be carried out by circulating fluid, such as water, through the at least one tube 501 that forms the corresponding cooling coil. Circulating fluid through a tube can avoid damaging or otherwise contaminating electrical components associated with the heating device or other parts of the fusion draw apparatus 101 with fluid such as water.

As further shown in FIG. 6, the method can selectively operate the cooling coils 403a-e to control the transverse temperature profile of the glass ribbon 103. For example, the heat sensors 627 can sense the temperature of the glass ribbon 103 at different positions along the width of the glass ribbon. The heat sensors 627 can then send feedback to the computer controller 619 by way of communication lines 629. Based on the feedback, the computer controller can adjust the pump 613 and or one or more of the solenoid flow valves 617 to independently adjust the cooling flow of fluid through one or more of the cooling coils 403a-e. As such, methods are possible to adjust the cooling rate of at least one of the cooling coils 403a-e without adjusting the cooling rate of at least another one of the cooling coils. Moreover, the plurality of cooling coils 403a-e may be selectively operated based on temperature feedback to provide a control system that operates the cooling coils based on the sensed temperatures.

In further examples, the temperature profile can be controlled by selectively adding heat with at least one of the plurality of heat devices 413a-e positioned along the cooling axis 405a. In one example, the computer controller 619 can automatically adjust the heat added by each of the heating devices based on feedback sensed by the heat sensors 627. Example methods can involve cooling with the heating devices 413a-e without the use of the cooling coils 403a-e. For example, the fluid may be drained out of the cooling coils, wherein the high-temperature metal of the at least one tube of the cooling devices allows the cooling coils to maintain structural integrity within the high temperature environment while providing little, if any, interference of heating the portions of the glass ribbon with the respective heating devices. In operation, the outer portions of the glass ribbon 103 near the edges 103a, 103b naturally tend to cool faster than the central portion of the glass ribbon 103. As such, the temperature sensed by the outer sensors 627 associated with cooling zones 601a, 601e may determine that the outer portions of the glass ribbon 103 are cooling too quickly. In response, the computer controller 619 may activate the outer pair of heating devices 413a, 413e at a higher temperature relative to the remaining heating devices to provide a more even cooling of the glass ribbon across the width.

Alternatively, the heating devices may be turned off, wherein cooling is conducted with the cooling coils 403a-e. In this example, temperature sensed by the heat sensor 627 associated with the central cooling zone 601c may indicate that the central portion of the glass ribbon includes a relatively high temperature. In response, the computer controller 619 may increase the flow rate of fluid through the inner cooling coil 403c to increase the cooling rate of the central cooling zone 601c. As such, the central cooling coil may cool at a relatively higher rate to provide a more even cooling of the glass ribbon across the width.

In still further examples, the heating devices and cooling coils may be operated at the same time. For instance, heating applied by the heating device can be modified by cooling with a respective cooling coil to provide fine tuning of the effective cooling rate applied by the respective cooling zone.

As further illustrated, the relatively different transverse widths “W₁”, “W₂” and “W₃” may be provided to help facilitate larger heat transfer in areas where cooling rate adjustment is needed the most. For example, the outer heating devices 413a, 413e may be associated with relatively larger widths “W₁” to help apply heat at a greater rate to the outer edges to compensate for faster cooling at the edges that would otherwise provide an undesirable transverse temperature profile.

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

1-19. (canceled)

20. A method of producing a glass ribbon including the steps of:
(I) drawing molten glass in a draw direction into a viscous zone to form a glass ribbon including opposed edges extending in the draw direction, wherein the opposed edges are spaced apart along a width of the glass ribbon that is transverse to the draw direction;
(II) drawing the molten glass from the viscous zone into a setting zone downstream from the viscous zone, wherein the glass ribbon is set from a viscous state to an elastic state;
(III) drawing the glass ribbon into an elastic zone downstream from the setting zone; and
(IV) controlling a transverse temperature profile of the glass ribbon along the width of the glass ribbon in at least one of the viscous zone, the setting zone and the elastic zone, wherein the step of controlling the temperature profile includes selectively removing heat from at least one of a plurality of cooling coils positioned along a cooling axis that is transverse to the draw direction.

21. The method of claim 20, further comprising the step of operating the plurality of cooling coils such that each cooling coil forms an associated one of a plurality of cooling zones that are aligned with one another to create a row of cooling zones along the cooling axis.

22. The method of claim 20, wherein removing heat from the at least one of the plurality of cooling coils is carried out by circulating fluid through at least one tube that forms the corresponding cooling coil.

23. The method of claim 20, further comprising the step of adjusting a cooling rate of at least one of the cooling coils without adjusting a cooling rate of at least another one of the cooling coils.

24. The method of claim 20, further comprising the step of selectively operating the plurality of cooling coils to control the transverse temperature profile of the glass ribbon.

25. The method of claim 20, further comprising the steps of sensing a temperature of the glass ribbon at different positions along the width of the glass ribbon and selectively operating the plurality of cooling coils based on the sensed temperatures.

26. The method of claim 20, wherein the step of controlling the temperature profile includes selectively adding heat with at least one of a plurality of heating devices positioned along the cooling axis.

27. The method of claim 26, further comprising the step of providing a plurality of temperature control modules positioned along the cooling axis, wherein each of the temperature control modules includes at least one of the plurality of cooling coils and at least one of the plurality of heating devices.

28. The method of claim 27, further comprising the step of replacing one of the temperature control modules with a new temperature control module while drawing molten glass in the draw direction.

29. (canceled)

30. The method of claim 27, further comprising the step of operating at least one of the temperature control modules to simultaneously cool with the corresponding cooling coil and heat with the corresponding heating device.

31. The method of claim 20, wherein the method comprises a down draw process.

32. The method of claim 31, wherein the down draw process comprises a fusion down draw process.

33. The method of claim 20, wherein each cooling coil of the plurality of cooling coils comprises at least one tube comprising a bent serpentine shape comprising sequentially arranged and oppositely facing U-shaped segments that are coplanar and arranged in series along the fluid path.
